(19) United States
(12) Patent Application Publication
(10) Pub. No.: US 2012/0125046 A1
(43) Pub. Date: May 24, 2012

(54) MAGNETIC JEWELRY ARTICLE HOLDER

(75) Inventors: Sarah A. VANDER WAL, Rockford, MI (US); Alycia SHAPIRO, New York, NY (US)

(73) Assignee: Stylelcon Solutions LLC, New York, NY (US)

(21) Appl. No.: 13/298,789

(22) Filed: Nov. 17, 2011

Related U.S. Application Data
(60) Provisional application No. 61/458,184, filed on Nov. 19, 2010.

(51) Int. Cl. A44C 13/00; H01F 7/02

(52) U.S. Cl. 63/1.18; 24/303

(57) ABSTRACT

A piece of magnetic jewelry including a pair of opposing magnet-holding housings containing magnets with opposite facing polarities and having a locking member and a base connected by a flexible elongated member whereby the piece of jewelry can be attached to textile while allowing an article, such as eyeglasses or the like, to be held on the flexible elongated member is disclosed.

This application claims the priority benefit of U.S. Provisional Patent Application No. 61/458,184, filed Nov. 19, 2010, which is hereby incorporated by reference in its entirety.

### FIELD OF THE INVENTION

The present invention relates generally to a piece of magnetic jewelry which is capable of attachment to textile, and more particularly to a piece of magnetic jewelry capable of securely holding an article to textile.

### BACKGROUND OF THE INVENTION

Conventional ways of holding eyeglasses, such as reading glasses or sunglasses, or the like, when not in use include placing them in a shirt or coat pocket or in a backpack or hand bag. However, eyeglasses as well as other items, can be damaged or lost upon falling out of a shirt or coat pocket or upon being crushed in backpacks or hand bags. In an effort to minimize or avoid this problem, a cord has been attached to each side of the eyeglass frame so that the glasses may hang around a person's neck. The eyeglasses can then hang from around the neck of the individual when not being used. Thus, sunglasses held in this manner are always hanging from around a person's neck when not in use. Similarly, sunglasses can be hung around a person's neck when not in use by attaching a retainer, such as a cord or strap, to each earpiece of the sunglass frame. These too are always hanging from around a person's neck when not being worn on the eyes.

The are many ways to attach a piece of jewelry to a person's clothing, particularly decorative jewelry, including pinning the jewelry by piercing the clothing with a pin or using clamps to securely hold the jewelry. Individuals are reluctant to degrade or destroy the clothing material in this manner, particularly when the material is expensive or delicate. A piece of jewelry can be attached to an individual's clothing in accordance with the present invention without piercing or damaging the fabric in a manner set forth above.

Necklaces are typically fastened around a person's neck by the use of a magnetic clasp, which includes a pair of magnets mounted to each end of the necklace. This type of magnetic clasp does not provide a very reliable connection since the ends of the necklace can easily be pulled apart by a strong force.

U.S. Patent Application Publication No. 2010/0083699 to Conigliaro discloses a jewelry article for holding eyeglasses or other articles to a person's clothing by using two magnets connected together with a chain or cord. As shown in FIGS. 2 and 6, the circular magnets 21 and 27 are mounted in holding cups 20 and 26 and placed on either side of a piece of clothing. One disadvantage of this design is that since the opposing magnet and cup holder surfaces are planar, the magnet holding cups can be rotated in different directions causing the magnets to slide sideways relative to one another and increase the likelihood of disengaging. This is particularly evident when the chain or cord connected to each holding cup may be pulled in opposing directions by the action of the article held therein catching on another article, or the action of the movement of the person, or the like.

A piece of magnetic jewelry in accordance with the present invention avoids or minimizes these problems and permits attachment to textile, such as an individual's clothing, without having to damage or pierce holes in the clothing while holding an article, such as a pair of sunglasses or the like, and provides a secure connection between the magnets in a manner not found in the prior art.

### SUMMARY OF THE INVENTION

One aspect of the present invention provides a piece of magnetic jewelry including a first magnet-holding housing having a locking member post on a first side thereof and a base portion, the first housing having a permanent magnet with a first polarity side facing outward mounted therein on the first side; a second magnet-holding housing having a locking member indent on a second side thereof and a base portion, the second housing having a permanent magnet with a second polarity side facing outward mounted therein on the second side, the first and second polarities being opposite polarities and the post and indent having complementary mating surfaces; and a flexible elongated member having two end portions, wherein one end portion is connected to the base of the first magnet-holding housing and the other end portion is connected to the base of the second magnet-holding housing, whereby the piece of jewelry can be attached to textile with the first magnet on one side and the second magnet on the other side of a portion of the textile with the first polarity side facing the second polarity side and the locking member post facing the complementary locking member indent so as to force a portion of the textile into the indent thereby locking the magnets in place and attaching the jewelry to the textile while allowing an article to be held on the elongated member.

Another aspect of the present invention provides the piece of magnetic jewelry with an ornamental face. One of the magnet-holding housings is provided with an ornamental face on the side opposite the magnet side with the ornamental surface thereof being displayed on the textile.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a perspective view of the front side of the magnetic jewelry article holder of the present invention;

FIG. 2 is a perspective view of the back side of the magnetic jewelry article holder of FIG. 1;

FIG. 3 is a perspective view of the magnetic jewelry article holder of FIG. 1 with the magnets connected together;

FIG. 4 is a perspective view of the front side of the magnetic jewelry article holder having an ornamental face thereon of the present invention;

FIG. 5 is a perspective view of the back side of the magnetic jewelry article holder of FIG. 4; and

FIG. 6 is a cross-sectional view of the magnetic jewelry article holder of FIG. 4 attached to a portion of textile.

### DETAILED DESCRIPTION

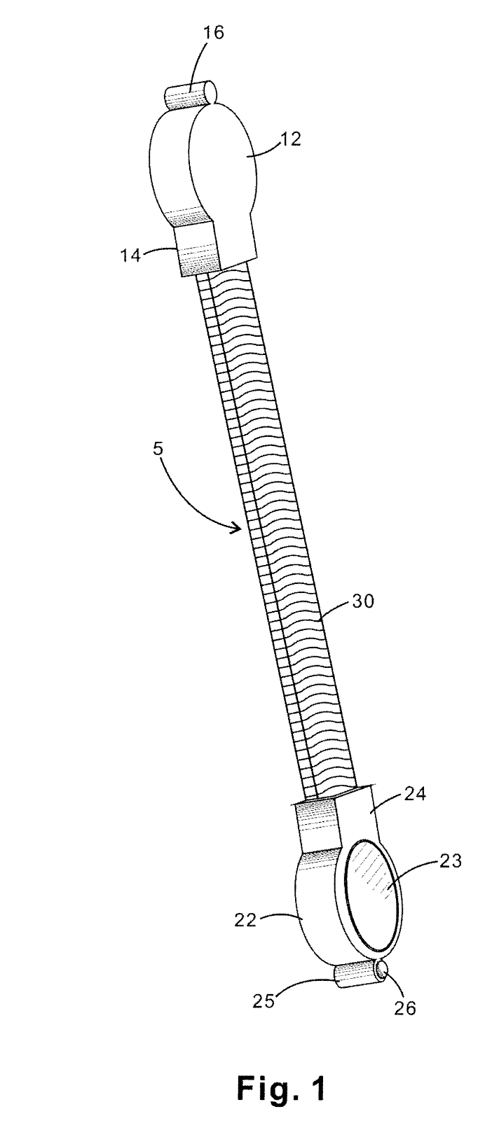

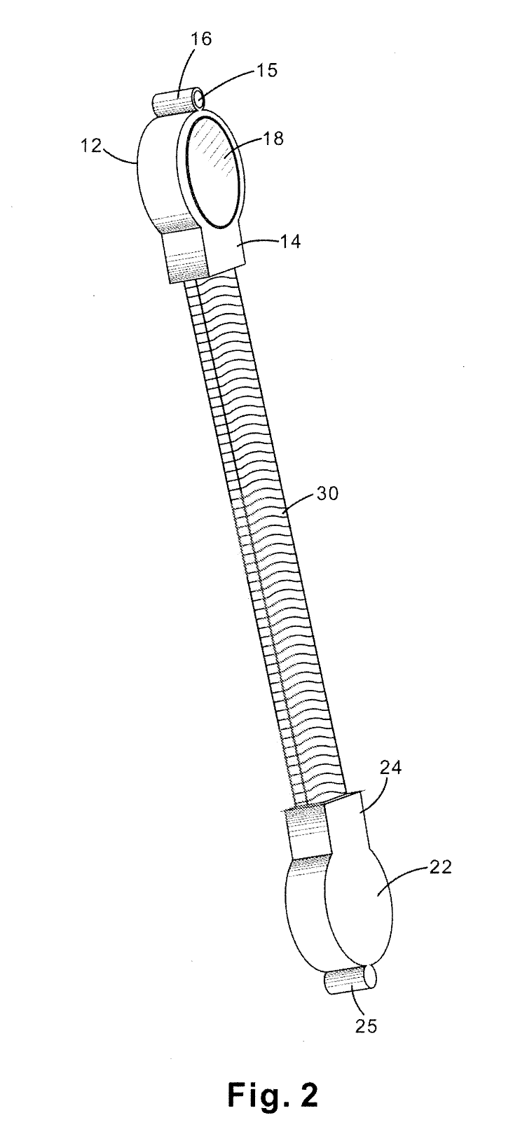

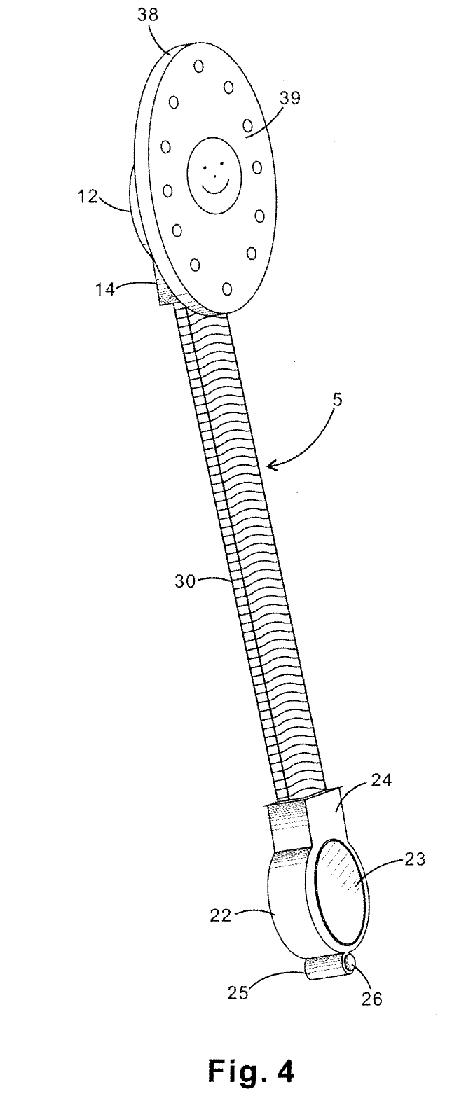

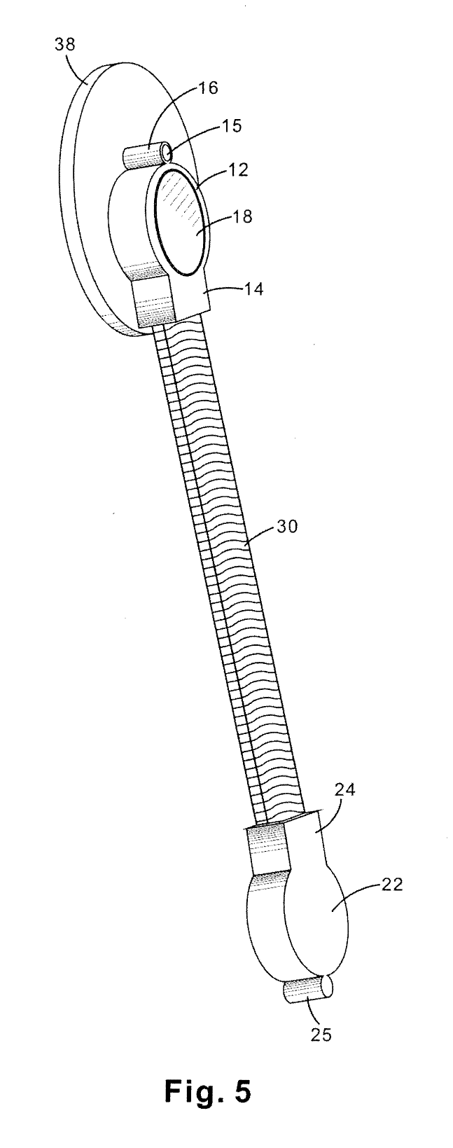

Referring to FIGS. 1 through 5, the magnetic jewelry article holder 5 has magnet-holding housings 12 and 22 connected by a flexible elongated member 30. The magnet-holding housings 12 and 22 are non-magnetic and preferably made of a non-ferric or non-magnetic material, which is preferably, alloys, epoxy, rubber, and costume jewelry base metal, such as raw brass, copper, pewter, white metal, surgical steel, and plated base metals, and the like. The first magnet-holding housing 12 has a base 14 and locking member 16 with a magnet 18 mounted therein. The base 14 of the housing 12 is attached to one end of the flexible elongated member 30. The magnet 18 can be any high power magnet, preferably a permanent magnet, more preferably a rare earth magnet, such as a neodymium-iron-boron (NdFeB) magnet. The present invention uses permanent magnets for attaching items to a textile, such as a person's clothing, with the textile in between the two permanent magnets. These magnets can securely hold the piece of jewelry to the textile while supporting an article. The locking member 16 of the magnet-holding housing 12 has an indent 15 which has a hollow shape to accommodate a portion of the, for example, fabric of the clothing. In addition to a portion of clothing, the textile can form a portion of a window treatment, drapery, hand bag, napkin, as for example, when the magnetic jewelry is used as a napkin ring, or the like.

A second magnet-holding housing 22 has a base 24 and locking member 25 with a magnet 23 mounted therein. The base 24 of the housing 22 is attached to the other end of the flexible elongated member 30. The locking member 25 of the magnet-holding housing 22 has a post 26 which has a complementary shape to that of indent 15, such that when the magnets are attached to either side of a portion of textile, the post urges the textile into the indent to effectively lock the magnets in place. Preferably, the post is a pin, rod, or the like. Preferably, the indent is a void, hole, cavity, or the like. Although the locking member pair 16 and 25 is shown with rounded indent/post complementary shapes 15 and 26, other complementary shapes are suitable for use in the present invention.

The elongated member 30 is preferably a flexible jewelry-type chain, such as a herringbone chain, or a cord, strap, or the like, which is attached to the base of the magnet-holding housing by gluing, such as by using an epoxy adhesive, soldering, or the like, in a manner sufficient to support an article, such as a pair of eyeglasses, suspended over the jewelry chain when not in use by an individual. Preferably, the base of the magnet-holding housing is provided with a cavity (not shown) suitable to accommodate the end of the elongated member 30 for attachment thereto. The elongated member 30 is preferably made from metal, rubber, silicone, epoxy, and the like.

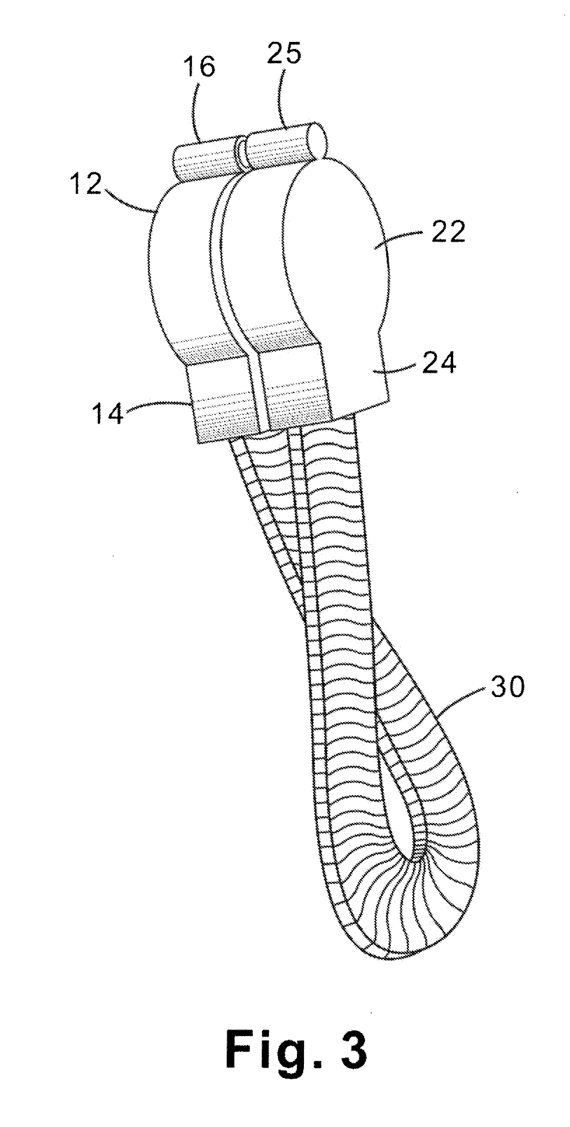

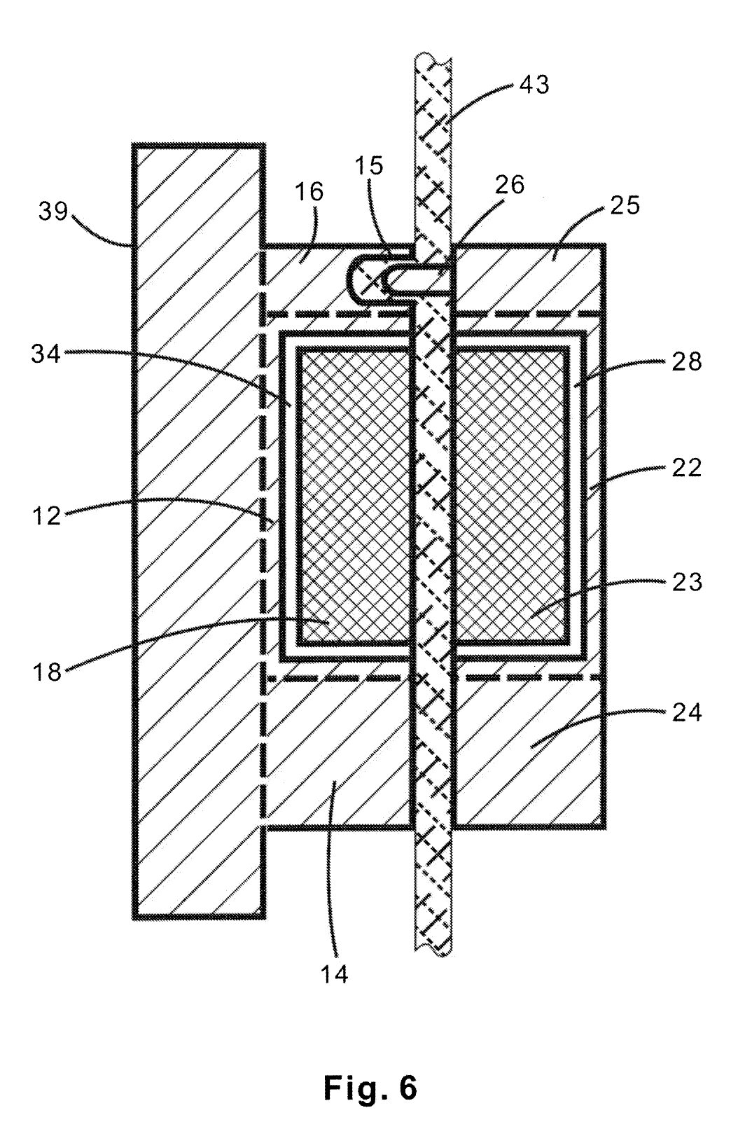

The magnets 18 and 23 are mounted in magnet-holding housings 12 and 22, respectively, with the exposed surfaces of the magnets having opposite polarity to each other so that the magnets are attracted to each other when they are brought in contact together, as shown in FIG. 3. The magnets can be mounted within the housings by gluing or other methods known in the art. The magnets are held together with sufficient force to remain attached to the textile and are prevented by the locking members 16 and 25 from disengaging by a side-ways sliding of one magnet relative to the other. The magnets are sufficiently strong enough to enable the housings to securely clamp onto a portion of textile and be locked into place by the housing locking members without the jewelry coming loose, as shown in FIG. 6. Although shown with a single locking member pair, the magnet-holding housings can be provided with multiple locking member pairs, as desired.

In FIG. 6, the magnet-holding housing 22 is shown with the magnet 23 mounted therein with an adhesive 28, such as an epoxy adhesive, and disposed on one side of a portion of textile 43. The magnet 18 is shown mounted within the magnet-holding housing 12 by an adhesive 34, such as an epoxy adhesive, and placed on the other side of the textile 43. The non-magnet side of the magnet-holding housing 12 is provided with a decorative face 39 so as to display the decorative face on the textile. The decorative face 39 may have an ornamental item or design positioned thereon.

In use, the magnets of the jewelry article holder 5 are separated, as shown in FIGS. 1, 2, 4, and 5. A magnet-holding housing is placed on one side of a portion of textile, such as a clothing blouse or sweater collar or shirt pocket and the flexible elongated member 30 is wrapped around the edge of the clothing. The other magnet-holding housing is aligned and positioned with the first magnet-holding housing with the textile in between, as shown in FIG. 6. The magnets are attracted to each other by the forces of the opposing polarities. The post of the locking member has a complementary shape to that of indent of the opposing locking member, such that when the magnets are attached to either side of the textile, the post forces textile into the indent to effectively lock the magnets in place and prevent side-ways sliding of the magnets. It can be appreciated that although magnet-holding housing 12 is provided with the decorative face 39 as shown in FIG. 6, alternatively magnet-holding housing 22 can be provided with the decorative face 39, as desired, with the ornamental surface being displayed on the textile. An article, such as a pair of eyeglasses or the like, can then be suspended from the flexible elongated member 30 where, as desired, it can be easily accessible for removal and use. In this manner, eyeglasses are temporarily held to clothing by a decorative piece of magnetic jewelry, without piercing the clothing fabric.

A process for manufacturing the magnetic jewelry of the present invention includes preparing suitable die casting molds for the magnet-holding housings. The magnet-holding housing having the post and base and the magnet-holding housing having the indent and base are cast from a costume jewelry base metal to the desired shape each having a cavity for the magnet and a cavity in the base for the chain. One of the housings has a decorative face on the side opposite the magnet cavity. Jewelry stones are glued to the surface of the jewelry member of the housing. A flexible jewelry chain is cut to the desired length. Iron/steel permanent magnets are then mounted in each housing by gluing the magnets into the housing cavity using epoxy adhesive #118 available from RBC Industries, Inc., Warwick, R.I. Next, an end of the jewelry chain is placed in the cavity of each base and glued with epoxy adhesive to the base of the housing. The finished product is then ready for use when the glue dries.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A piece of magnetic jewelry comprising:
a first magnet-holding housing having a locking member post on a first side thereof and a base portion, the first housing having a permanent magnet with a first polarity side facing outward mounted therein on the first side;
a second magnet-holding housing having a locking member indent on a second side thereof and a base portion, the second housing having a permanent magnet with a second polarity side facing outward mounted therein on the second side, the first and second polarities being opposite polarities and the post and indent having complementary mating surfaces; and
a flexible elongated member having two end portions, wherein one end portion is connected to the base of the first magnet-holding housing and the other end portion is connected to the base of the second magnet-holding housing, whereby the piece of jewelry can be attached to textile with the first magnet on one side and the second magnet on the other side of a portion of the textile with the first polarity side facing the second polarity side and the locking member post facing the complementary locking member indent so as to force a portion of the textile into the indent thereby locking the magnets in place and attaching the jewelry to the textile while allowing an article to be held on the elongated member.

2. The piece of magnetic jewelry of claim 1, further comprising one of the magnet-holding housings having an ornamental face on the side thereof opposite the magnet side with the ornamental face being displayed on the textile.

3. The piece of magnetic jewelry of claim 1, wherein the elongated member comprises a metal jewelry chain.

4. The piece of magnetic jewelry of claim 1, wherein the elongated member comprises a flexible jewelry cord.

5. The piece of magnetic jewelry of claim 1, wherein the first and second permanent magnets comprise rare earth magnets.

6. The piece of magnetic jewelry of claim 1, wherein the locking member is disposed on the magnet-holding housing opposite from the base.

7. The piece of magnetic jewelry of claim 1, wherein the article is a pair of eyeglasses.

8. The piece of magnetic jewelry of claim 1, wherein each housing has a cavity in the base portion thereof to accommodate an end of the flexible elongated member.
